(19) United States
(12) Patent Application Publication
(10) Pub. No.: US 2017/0032288 A1
(43) Pub. Date: Feb. 2, 2017

(54) WAITING LINE TRANSACTION SYSTEM AND METHOD

(71) Applicants: Robert Popkey, Long Grove, IL (US); Michael Rzeznik, Lake Zurich, IL (US)

(72) Inventors: Robert Popkey, Long Grove, IL (US); Michael Rzeznik, Lake Zurich, IL (US)

(73) Assignee: Zoomline IP Holdings, LLC, Long Grove, IL (US)

(21) Appl. No.: 15/230,654

(22) Filed: Aug. 8, 2016

Related U.S. Application Data
(63) Continuation of application No. 13/345,817, filed on Jan. 9, 2012, now abandoned.

(51) Int. Cl. G06Q 10/02; G06Q 10/06

(52) U.S. Cl. CPC G06Q 10/02; G06Q 10/063

(57) ABSTRACT

An automated waiting line transaction management system that provides customers the option of queuing up and waiting in the standard venue line for goods and/or services or purchasing a pass to bypass the normal line. A merchant sets pass prices, and at the point of purchase, a time sensitive code is sent to the customer for use at the venue to gain priority access thereto.

### CROSS-REFERENCE TO RELATED APPLICATION

This application is a continuation of utility application Ser. No. 13/345,817, filed Jan. 9, 2012 entitled “Waiting Line Transaction Management System And Method” which claims the benefit of priority under USC §119(e) of provisional application No. 61/543,451, filed Oct. 5, 2011 entitled “Waiting Line Transaction Management System”, hereby incorporated by reference herein.

### BACKGROUND OF THE INVENTION

I. Field of the Invention

The present disclosure relates generally to managing access to products and services at a location generally having a queue of patrons. In particular, the present disclosure is directed to systems, methods, and apparatuses for managing the transactions enabling a customer to bypass the ordinary waiting line at a merchant location.

II. Description of the Prior Art

There are a number of circumstances where people have to wait in line in order to do something. At restaurants, for example, whether the customer has made a reservation or not, they often need to wait in line for the next available table to open up. Other situations where people have to wait in line include gaining admission to clubs, buying tickets for sporting events and concerts, gaining admission into amusement parks and waiting for particular attractions therein, gaining admission to museums and other tourist attractions, checkout lines at stores, airport security, etc. Basically, a line forms any place where the number of people arriving to take advantage of goods or services at any one time exceeds the speed at which any one customer or group of customers can be served.

Whether it is the customer waiting in the line or the merchant needing to form the line, these circumstances create sacrifice. As to the customer, the time spent in line, and thus the sacrifice, is typically the wasted time. If possible, the customer would much rather come back later when there is no line so that he can do other things instead of waiting in line. For example, in the amusement park setting, there may be hundreds of rides, shows, shops, games, parades, displays, and food services. If a customer has to wait in line for each attraction, the customer may only be able to utilize a small number of attractions in any particular visit. Not only is the customer frustrated at not being able to access more attractions, but the customer is frustrated for having paid for an admission to attractions not used. Another example from the customer side is where a professional needs to entertain a client with a dinner and/or at a nightclub. Whether reservations have been made or not, there are times when the arriving group needs to wait in line for the next available table at the restaurant or club. While the client obviously does not want to wait in a line, this type of situation may turn out to be particularly risky for the professional.

Turning to the merchant side, it is the lost revenue that is the sacrifice. Referring back to the amusement park example, assuming that customers spend at least 50% of their time in the park standing in a waiting line for different attractions; that means that at least 50% of the time the customers are not able to make purchases of merchandise, food and beverages, etc. As a result, the theme park loses significant potential income opportunities because their customers are spending too much time waiting in lines. Similarly, referring back to the restaurant or club example, rather than risk upsetting and possibly losing the client due to a long wait, the professional would probably rather entertain his client at an establishment without a wait. Therefore, the merchant loses the business.

No matter how the line forms or what type of parties are involved, time is wasted. Life is too short to be spending it in a waiting line. While time has always been associated with money, it has never been as true as it is now during the fast pace of life today. As consumers experience a greater squeeze on their time, short waits seem longer than ever before. The changing demographics of the last decade have made time more valuable now than the past. People work longer and more varied hours, and due to stagnating wages and a drastic unemployment shift, many are forced to work overtime or hold second jobs to maintain their lifestyle. This has resulted in weekly U.S. leisure time declining from 26.2 hours to 16.6 hours. Accordingly, such pressures have shifted consumers values placing greater value on their free time.

An attempt to solve the waiting in line problem, and one that has been in use in the restaurant environment (for example) for some time is the simple reservation. A customer merely contacts the merchant by phone, internet, or otherwise and reserves a time. While both the merchant and the customer know the time of the reservation, there are still issues involved. From the customer perspective, there are times when they still need to wait for the previous customers to finish. From the merchant perspective there are times when the customers simply don't show up and therefore the unused reservation results in lost revenue. In fact, many restaurant chains have now done away with reservations due to the 20% to 40% no show rate.

Another attempt to solve this waiting in line problem is the manual (or kiosk) so-called “call-forward” queue management system. This is particularly prevalent in the deli department of supermarkets where, rather than form a waiting line, each customer pulls off a sequentially numbered paper ticket from a preprinted roll in a dispenser to establish priority in a first come first serve service queue. Each ticket represents a request for service by the service personnel to fulfill an order for goods, and service personnel satisfy these requests for service by “calling forward” each ticket number. The customer then answers the call and places the order with the service person for immediate fulfillment. While the customer is free to complete his grocery shopping until his number is called, he does not know how long the wait is going to be and accordingly must always stay close to the deli counter. As such, this solution has limited appeal.

The amusement park environment has seen numerous attempts to address the mutual sacrifices of both customer and merchant that are inherent in the long waiting lines associated with many of the attractions at the park. The most common attempt is the system that allows the customer to reserve a window in time to enjoy an attraction. For example, at 1:30 pm the customer wants to ride Roller Coaster X but there is a 90 minute wait posted outside the standby line. Rather than wait in the standby line, the customer obtains a reservation (in the form of a paper printout, virtual medium, or otherwise) with a return time of 4:00 to 5:00 pm, for example. He then has 2½ hours to enjoy other attractions before returning to Roller Coaster X, bypassing the standby line, and enjoying the ride with little or no wait. While the customer is free to use the intermediate time as he desires, in order to access the ride at the appropriate time, he will still need to allocate his time accordingly. Meanwhile, while the amusement park may receive an additional purchase from the customer, it is by no means an optimal arrangement.

Another attempt in the amusement park environment is some type of virtual wait daily pass. This pass will basically hold the position of the bearer in line electronically. Depending upon the price spent on such a pass, the customer may virtually wait as long as everyone else in the line is physically waiting, or may wait less, or even not at all. For example, the customer visits the attraction, and his pass is activated such that he is virtually waiting in line but can physically be visiting other attractions. When it is his turn, an alert is sent to the pass and he can then return and enjoy the attraction. Once again, while the customer can use the intermediate time as he desires, he still must be ready to attend the attraction he is virtually waiting in line for when the pass receives the alert. Otherwise he will miss his opportunity to enjoy the attraction. Additionally, while the park may receive some increased revenue from both the initial purchase of the daily pass and any intermediate purchases, such Passes are not utilized by the masses, and this revenue is not optimized.

Accordingly, it is a general object of this disclosure to provide systems, methods and apparatuses for addressing the deficiencies of the current practices regarding issues associated with waiting lines at merchant locations.

It is another general object of this disclosure to provide systems, methods and apparatuses for managing the transactions enabling a customer to bypass the ordinary waiting line at a merchant location.

It is more specific object of this disclosure to provide systems, methods and apparatuses for decreasing the amount of time wasted waiting in a line at a merchant location.

It is another more specific object of this disclosure to provide systems, methods and apparatuses for optimizing merchant revenue from customers who do not want to wait in line.

These and other objects, features and advantages of this disclosure will be clearly understood through a consideration of the following detailed description.

### SUMMARY OF THE INVENTION

According to an embodiment of the present invention, there is provided a customer waiting line management system for use with personal communication devices and a network including a first queue where customers access a merchant venue by waiting in line and a second queue where customers bypass the first queue to gain access. A merchant personal communication device establishes the price for a customer to purchase a pass for access to the second queue and the device authenticates the pass and permits access.

There is also provided an automated system for managing customer waiting time at a merchant venue for use with personal communication devices and a network where a merchant communication device establishes the price for a customer to purchase a pass for priority access to his venue. A merchant code is issued to the customer upon pass purchase and is accepted by a merchant authenticating device to permit priority access to the venue.

There is further provided an automated system for managing customer waiting time at a merchant venue for use with personal communication devices and a network including a server, a database of a plurality merchants and customers information. The server is in communication with the databases and personal communication devices of the merchants and customers to enable communication of fee information to enable a customer to purchase a token to gain priority access to a merchant venue.

There is further provided automated method of managing customer waiting time at a merchant venue comprising the steps of: providing a database representing customers; providing a database representing merchants; receiving an incoming user communication container a unique identifier associated with a specific customer in the database; providing the specific customer with options for identifying a participating merchant; providing the customer with information concerning the cost of purchasing a priority access pass to the merchant venue; receiving the merchant pass selection; automating payment for the pass; and issuing the pass to the customer to gain priority access to the merchant wherein the merchant authenticates the pass.

### BRIEF DESCRIPTION OF THE DRAWINGS

The present disclosure will be more fully understood by reference to the following detailed description of one or more preferred embodiments when read in conjunction with the accompanying drawings, in which like reference characters refer to like parts throughout the views and in which:

FIG. 1 is illustrative of a communication network environment in which preferred embodiments of the waiting line transaction management system of the present disclosure are implemented.

FIG. 2 is a request to register flow diagram for the waiting line transaction management system of the present disclosure.

FIG. 3 is a flow diagram for customer registration for the waiting line transaction management system of the present disclosure.

FIG. 4 is a flow diagram for merchant registration for the waiting line transaction management system of the present disclosure.

FIG. 5 is a flow diagram for customer sign in and use of the waiting line transaction management system of the present disclosure.

FIG. 6 is a flow diagram for merchant sign in and use of the waiting line transaction management system of the present disclosure.

FIG. 7 is a flow diagram of the monetary transactions within the waiting line transaction management system of the present disclosure.

FIG. 8 is a personal communication device (PCD) screen shot illustrating customer options for locating merchants utilizing the waiting line transaction management system of the present disclosure.

FIG. 9 is a PCD screen shot illustrating a map view of those merchants utilizing the waiting line transaction management system of the present disclosure.

FIG. 10 is a PCD screen shot illustrating a list view of those merchants utilizing the waiting line transaction management system of the present disclosure.

FIG. 11 is a PCD screen shot illustrating a category view of those merchants utilizing the waiting line transaction management system of the present disclosure.

FIG. 12 is a PCD screen shot illustrating the geo feature of the PCD as it utilizes the waiting line transaction management system of the present disclosure.

FIG. 13 is a PCD screen shot illustrating particular choices available from the location determined in FIG. 12.

FIG. 14 is a general system flow of the customer as he chooses a particular merchant utilizing the waiting line transaction management system of the present disclosure.

FIG. 15 is a PCD screen shot of some pertinent customer information.

FIG. 16 is a PCD screen shot of a QR code sent to the customer for use at the merchant.

FIG. 17 is a PCD screen shot of the merchant scanning the QR code of FIG. 16.

FIG. 18 is a PCD screen shot of the merchant confirming customer purchase.

FIG. 19 is a PCD screen shot of a merchant account statement of the waiting line transaction management system of the present disclosure.

FIG. 20 is a PCD screen shot of a merchant login for utilizing the waiting line transaction management system of the present disclosure.

FIG. 21 is a PCD screen shot illustrating the merchant control of the waiting line transaction management system of the present disclosure.

FIG. 22 is a PCD screen shot illustrating a real time updated merchant account utilizing the waiting line transaction management system of the present disclosure.

FIG. 23 is a general system flow of the customer as he chooses a particular merchant not utilizing the waiting line transaction management system of the present disclosure.

### DESCRIPTION OF THE PREFERRED EMBODIMENTS

The following description of the preferred embodiments is merely exemplary in nature and is in no way intended to limit the disclosure, its application or use.

The present waiting line transaction management system provides an automated system and means by which business owners and customers are able to reach each other sooner. In particular, the system provides customers the option of queuing up and waiting in the line for goods and services or purchasing a Pass to bypass the normal line. As such, merchants willing to offer priority access to their venues for a fee, and those customers willing to pay such a fee, are brought together. At the point of purchase, a time sensitive QR code (or the like) redeemable on the specified date or time, will be immediately sent to the customers smartphone. A participating merchant will have the ability to set prices based on time and date, or simply determine that he will accept whatever time the customer arrives, so long as it is on the date specified.

In the instance where the merchant venue is at capacity, those customers that have purchased a Pass will be offered first access as people leave. Accordingly, there is no difference with how the merchant would handle the issue, the merchant would simply draw next entry to the venue from the second queue Pass line, as opposed to the regular waiting line. Such a system enables the merchant to avoid lost revenues from no show patrons, ensuring full capacity on a first come first service basis, while offering a premium Pass for priority access for those customers that would otherwise walk away if faced with a long wait.

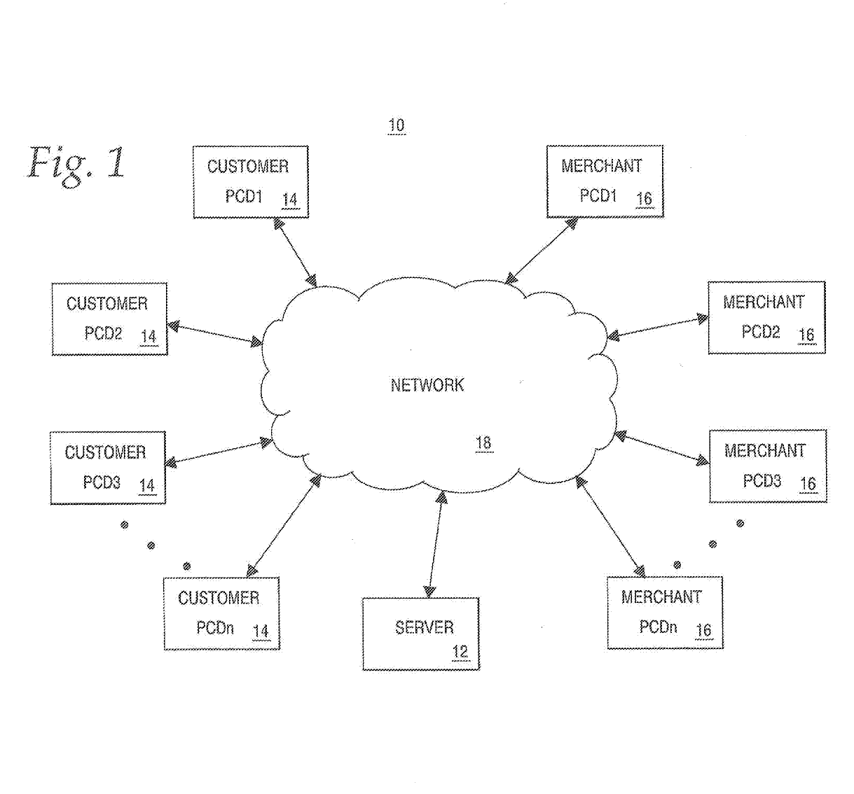

FIG. 1 is a schematic overview diagram of the communication network and computing environment in which the preferred embodiments are implemented. The preferred waiting line transaction management system 10 includes one or more servers 12, customer personal communication devices (“PCD”) 14 and merchant PCDs 16, linked together using a network 18, such as the internet. The network 18 may be comprised of any network known in the art including TCP/IP based networks (e.g. the Internet, an Internet), LAN, Ethernet, WAN, Token Ring, etc. Alternatively, there may be separate and different networks between components. Further, because the preferred embodiment of the network 18 is the Internet, there can be a huge number of users, both customer (Customer PCDn) and merchant (Merchant PCDn) simultaneously.

The servers 12 include database and database interface known in the art. The server 12, through its database, keeps current, accurate information about the users of the service, e.g., both customers and merchants. Information is preferably stored in a non-volatile storage system, such as one or more hard disk drives, used by the server 12 for storage. The server may load data from the storage system into volatile memory when processing. It is envisioned that the management system 10 will utilize multiple servers 12 at different physical locations to help ensure safety and security. It is further envisioned that the management system 10 may utilize off-site remote server services, such as a dynamic virtual private server (e.g. cloud server). In any event, the server 12 may comprise one or more separate computer systems to run the different components of the waiting line transaction management system 10. Accordingly, the server is capable of receiving and transmitting communications with the databases and otherwise.

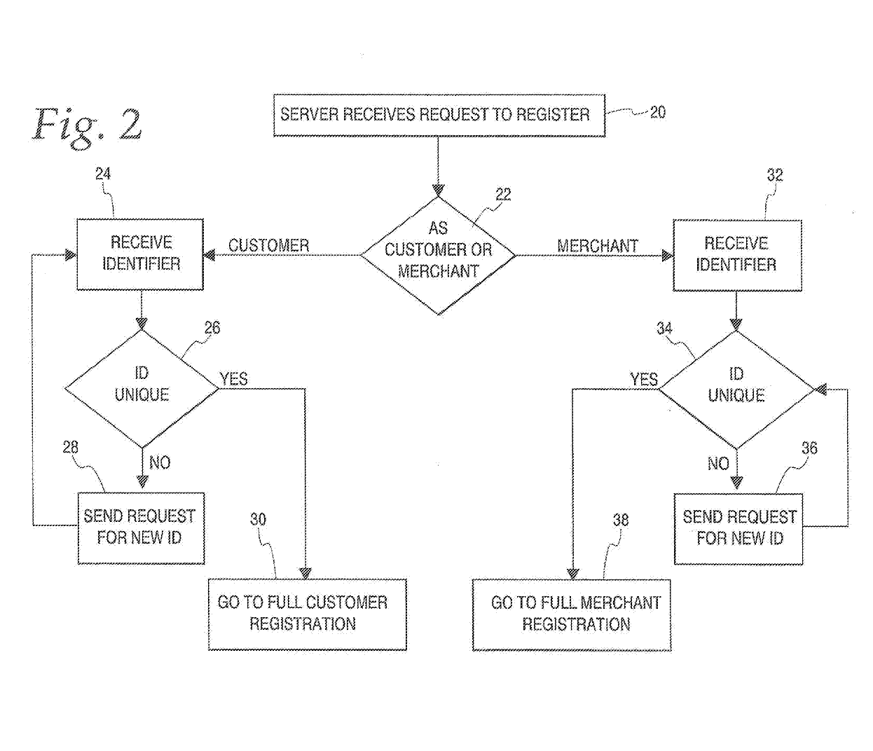

Before being able to use the management system 10, users, both customer and merchant, will need to register and create an account. Referring to FIG. 2, when the server receives a request 20 from a user to register, it must first determine 22 whether the user is registering as a customer or a merchant. If the user is registering as a customer, the system will receive identification data 24, preferably an email address and a password, and will determine whether the identification data is unique 26. If not unique, the system will send the user a request 28 for different identification data. If the user provides unique identification data, full customer registration proceeds 30. Similarly, if the user is registering as a merchant, the system will receive identification data 32, and will determine whether it is unique 34. If not unique, the system will send a request 36 for different identification data. If unique, full merchant registration proceeds 38.

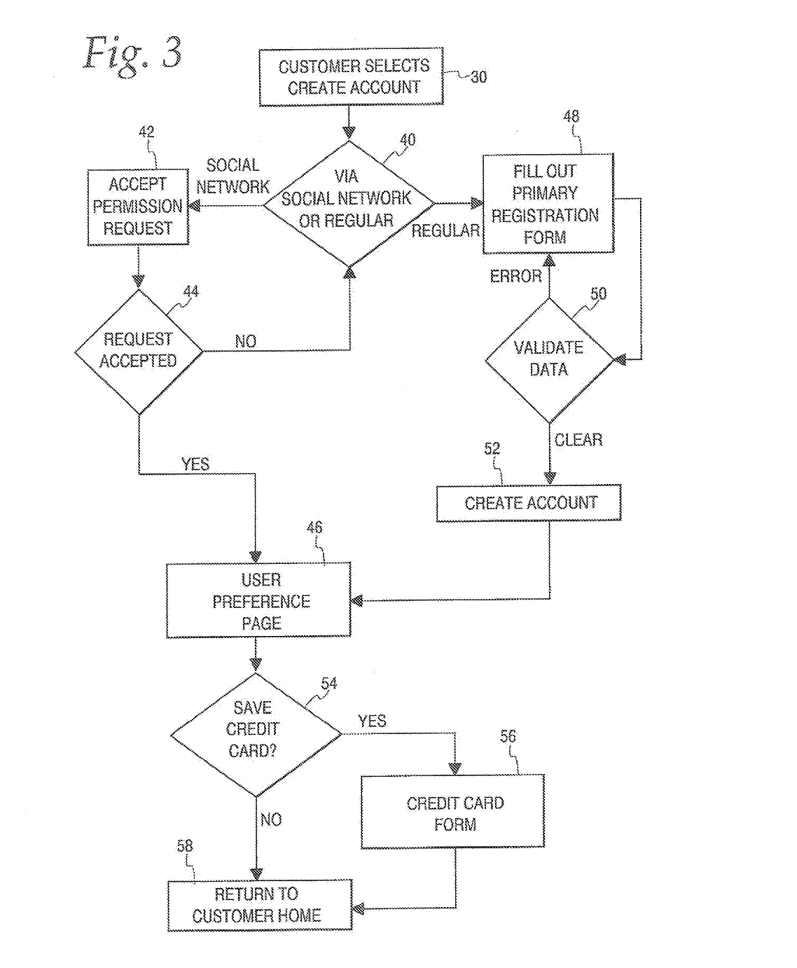

Turning first to FIG. 3 and customer registration 30. The customer registration process can be completed through a social network account (e.g. FACEBOOK®) or by providing the necessary information directly. Upon customer registration access, the user decides 40 how to provide his information. If he wants to use his information from a social network, then the system accepts his permission request 42 to use previously supplied information to the social network. The system then determines whether the available information is acceptable 44. If it is, then the user moves on to set-up his user preferences 46. If not, he is directed back to either choose 40 another social network or to provide information directly. If the user directly provides information, it is preferably a primary registration form 48 requiring basic information such as, for example, name, address, telephone number, etc. This information is then presented for validation 50, and once cleared, the user account is created 52 and the user moves on to set-up his user preferences 46 and sign the customer contract. Within the user preference set-up is the type of payment the user wants to use to purchase Passes. Options may include a third party clearing house (e.g. PAYPAL®), credit card, debit card, checking account, cash account, or otherwise. The user has the option of saving credit card information 54 via completion of a form 56 or returning directly to the customer home screen 58.

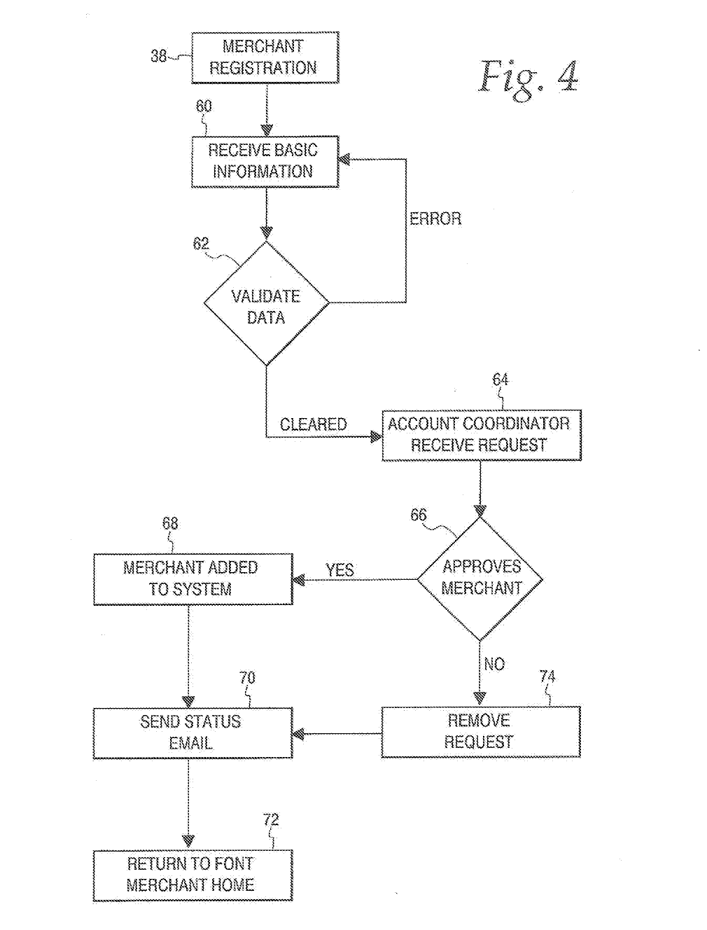

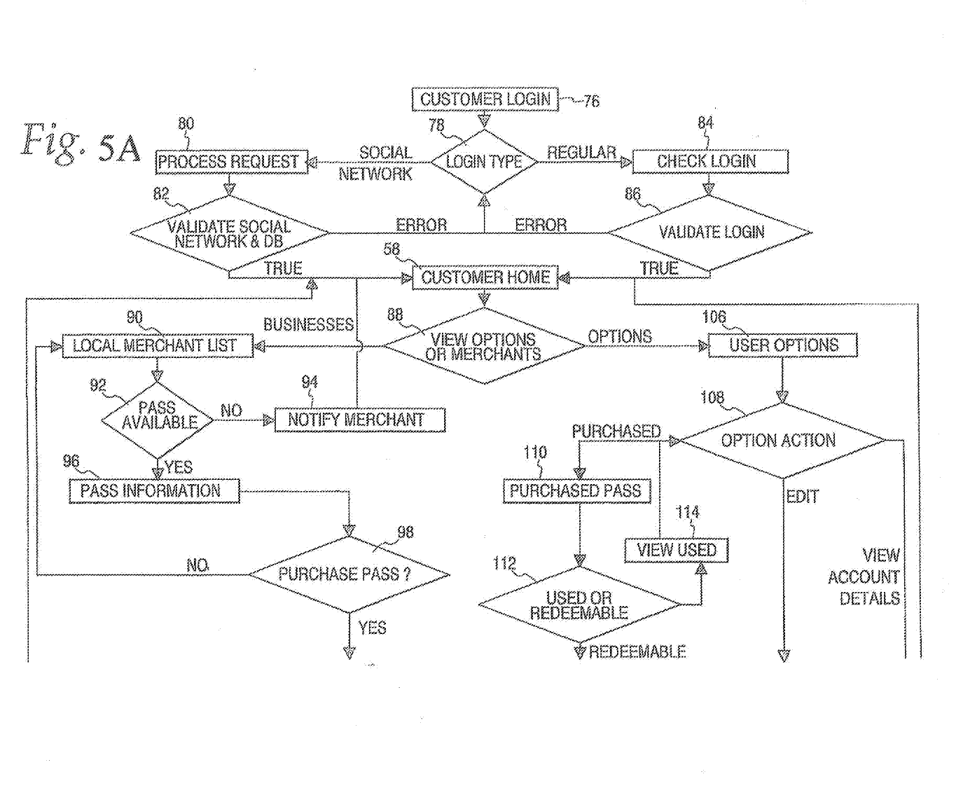

Turning now to FIG. 4 and merchant registration 38. Basic merchant information is provided 60, and may include, for example, name, address, telephone number, etc. Most importantly, the merchant preferably provides an account with bank routing numbers in order to receive funds from the management system 10. This information is then presented for validation 62, and once cleared, the system account coordinator receives the merchant request 64, for approval 66 into the system 10. If approved, the merchant is added 68 to the system, a status email is sent 70 and the merchant returns to the merchant home screen 72. If not approved, the request is removed 74, a status email is sent 70 and the merchant returns to the merchant home screen 72.

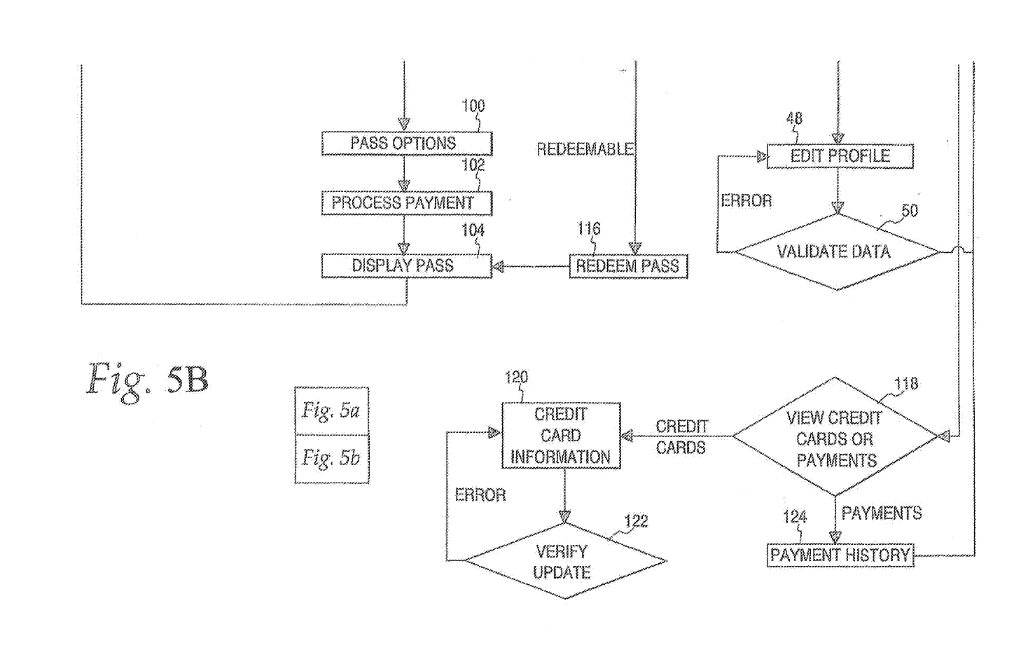

Once registered, the customer can activate and use the system. First, and turning now to FIG. 5, the customer needs to login 76. As with the registration process, the customer determines 78 whether he wants to login through a social network or directly. If through a social network, the system accepts the process request 80, and if validated 82, presents the customer home screen 58. If not validated, he is directed back to choose 78 another social network to login or login directly. If the customer directly logs in, the system accepts the request 84, and if validated 86, presents the customer home screen 58. If not validated, he is directed back to choose 78 a social network to login or attempt to login directly again.

From the customer home screen 58 the customer can then choose 88 to view his user options or find a merchant. If the customer chooses to find a merchant, a merchant listing 90 will be presented. Upon choosing a merchant, the system will determine 92 whether that particular merchant has a Pass currently available. If no Pass is available, the merchant is notified 94 and the customer returns to customer home 58. If a Pass is in fact available, then the Pass Price and other information 96 is presented and the customer has the opportunity 98 to purchase. If he does not purchase, then he returns to the merchant listing 90. If he does purchase, options 100 are presented (i.e. number of Passes, date, time, etc.), payment is processed 102 and the Pass is displayed 104.

Referring back to the choice 88 of viewing options or finding a merchant, if the customer chooses view options, then his user options are presented 106. He may then have a number of further choices 108, such as view purchase Passes, Edit Profile, and view account details. From the purchased pass 110 path he can then choose 112 whether he wants to view old or used Passes 114 or redeem a Pass 116 at a merchant. From the edit profile path 48, the customer can edit his previously provided information and/or add new information, and once the information is validated 50, he is returned to the customer home screen 58. From the view account details path, the customer can choose 118 whether to view credit card or other payment information 120 and will need to validate 122 any changes. Otherwise the customer may view his payment history 124 before returning to the customer home screen 58.

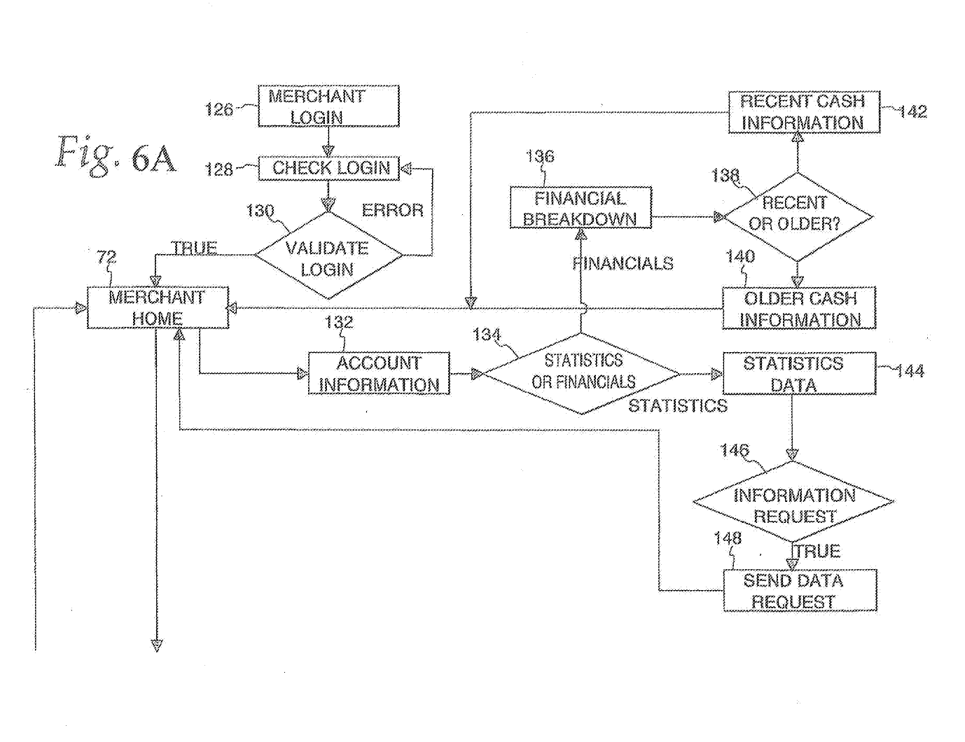

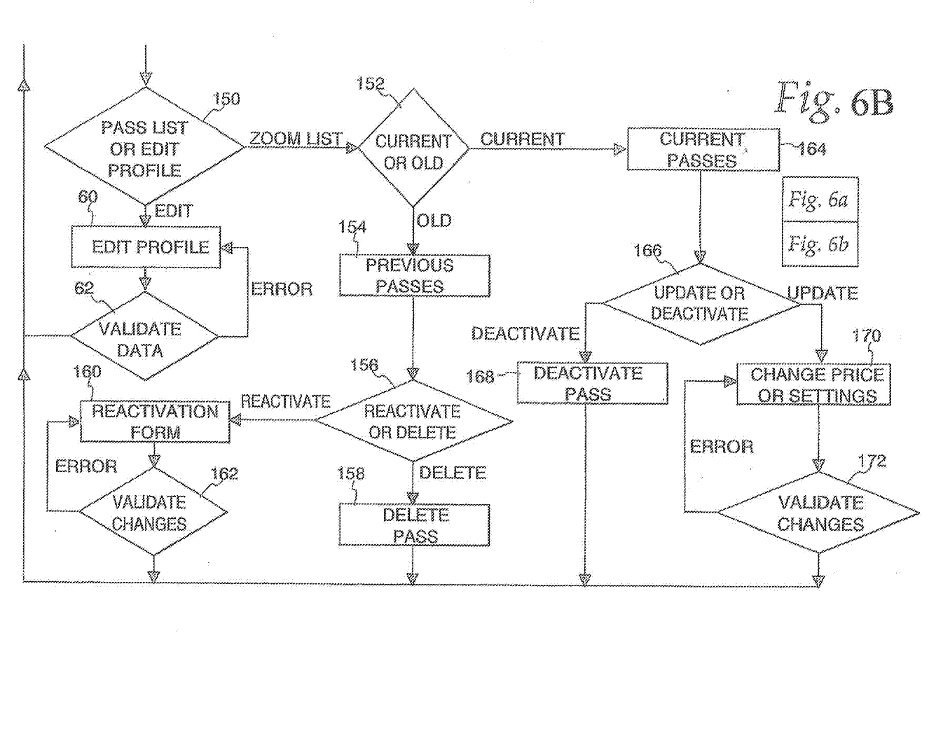

Once registered, the merchant can activate and use the system. First, and turning now to FIG. 6, the merchant needs to login 126. The system accepts the request 128, and if validated 130, presents the merchant home screen 72. From the merchant home screen 72, the merchant can then view account information, Pass list information, and edit his profile. If viewing account information 132, the merchant can choose 134 between statistics or financials. The financial breakdown 136 provides a further choice 138 of reviewing older cash information 140 or more recent cash information 142. If the merchant chooses 134 to view statistical data 144, he can request 146 certain information, and if it is available it will be sent 148.

If the merchant decides 150 to edit his profile 60, he can edit his previously provided information and/or add new information, and once the information is validated 62, he is returned to the merchant home screen 72. If the merchant decides 150 to access his Pass lists, he will first need to determine 152 whether he wants to view old Passes or current Passes. If he wants to access the previous Passes 154, he has the choice 156 of reactivating a Pass or deleting a Pass. As such, old Passes may be merely deleted 158 or the merchant can complete a reactivation form 160 which will need to be validated 162, before returning to the merchant home screen 72. On the other hand, if the merchant wants to access the current Passes 164, he has the choice 166 of deactivating a Pass or updating a Pass. As such, current Passes may be merely deactivated 168 or the merchant can change the Pass price or other settings 170, which will need to be validated 172, before returning to the merchant home screen 72.

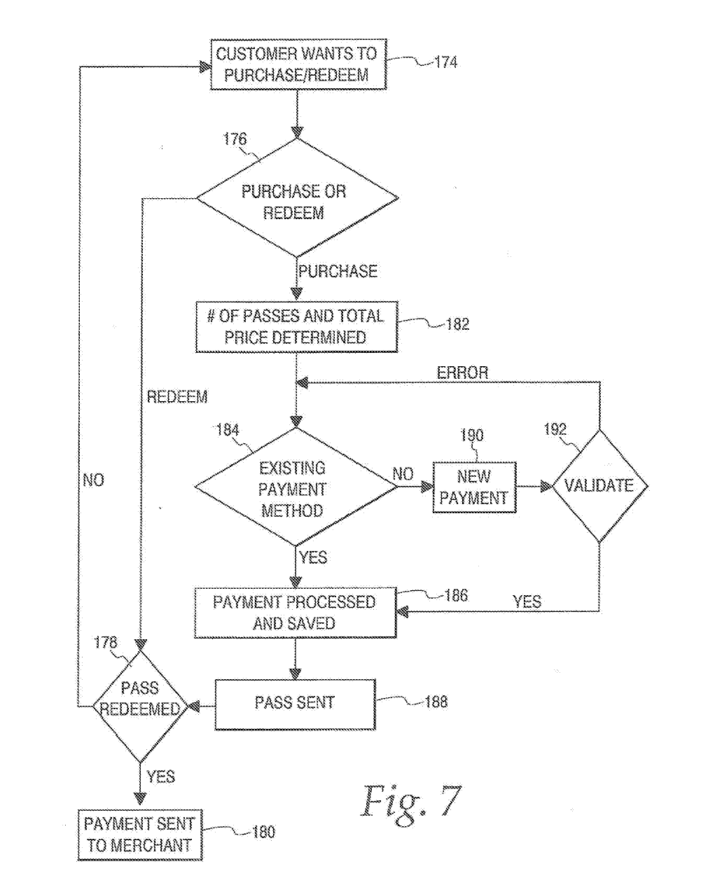

FIG. 7 depicts a simplified flow diagram of the monetary transactions within the waiting line transaction management system 10. The flow starts when the customer wants to purchase or redeem a Pass 174 and is given the choice 176 to do so. If he chooses to redeem, the Pass is presented to the merchant for authentication 178, and upon authentication, money is transferred from the system 10 to the merchant 180. If at the decisional block 176, the customer chooses to purchase, then the number of Passes and thus a total price is determined 182. The customer then decides 184 whether he will be using an existing payment method or a new method. If existing, the payment is processed and the amount of the total purchase price is transferred 186 to the system 10 and the Pass is sent 188 to the customer. Alternatively, if the customer want to establish a new method of payment, then the necessary information is collected 190, and once validate 192, payment is processed 186. This monetary flow diagram illustrates the preferred embodiment of merchant compensation upon Pass redemption. However, it will be understood that the merchant may be compensated upon purchase of the Pass regardless of whether the Pass was redeemed.

It will be appreciated that that the account coordinator and/or system host can be a merchant or a third party and that the account coordinator or system host can receive compensation for acting as the account coordinator or system host. For example, a third party account coordinator or system host can receive a percentage of the Pass fees and/or can, for example, be permitted to display advertisements in association with any of the interactive screens and thereby derive revenue from acting as an account coordinator or system host. It will further be appreciated that such compensation can be automated so that the account coordinator or system host is automatically compensated upon a fee transaction. Additionally, the compensation system can be configured to provide for alternate formulas for compensating the system host, account coordinator, merchant and/or user. For example, as discussed above, the system can be configured so that the merchant receives compensation from the Pass only if the Pass is redeemed. If the Pass is not redeemed within the time window then system host or account manager has the option of retaining the entire Pass fee, sharing some portion of the Pass fee with the merchant and/or refunding some portion of the Pass fee to the user. Alternatively, the system can be configured to automatically allocate respective portions of the Pass fee to the system host, account manager and/or merchant depending on differing formulae if the Pass is redeemed or not redeemed. The system can also be configured to reward the user by providing for frequent user discounts and or reward points.

Turning now to the particulars of the customer and merchant uses of the waiting line transaction management system, a number of representative examples will be shown and described. The following figures will illustrate such uses through the use of so-called smartphones. However, as previously discussed, it will be understood that use of the disclosed system is not limited to smartphones or any other particular personal communication device (“PCD”).

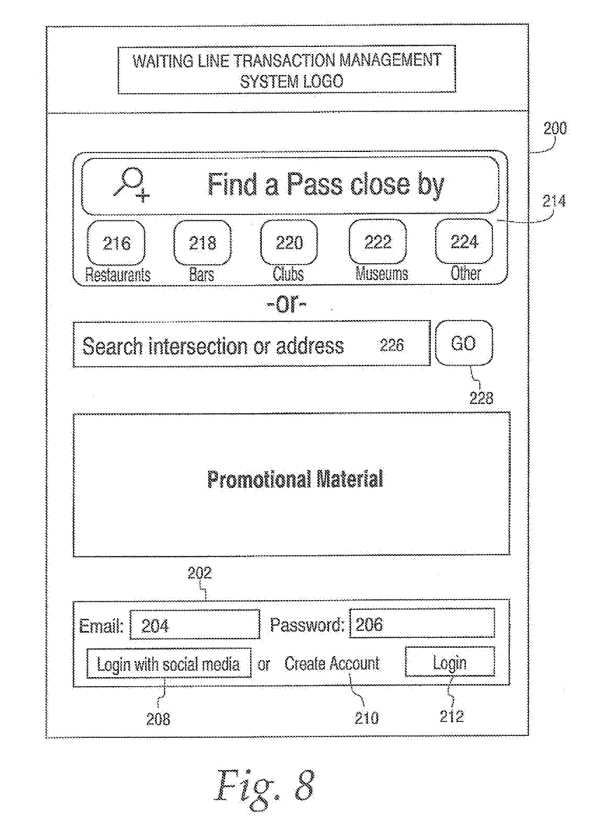

Referring to FIG. 8, when the customer desires to utilize the system, he merely activates the application on their PCD 200. Once activated and if not automatically logged in, the customer will need to login to the application through the login window 202. This may include entering an email address 204 and password 206, or optionally logging in through a social media account 208 (e.g. FACEBOOK®, LINKEDIN®, etc.). The customer can also create an account 210 via this window 202. Upon successful login 212 the customer application provides the user with numerous choices to locate participating merchants. For example, if the customer has previously setup their account with categories, these categories will be displayed in a choice window 214. Categories may include Restaurants 216, Bars 218, Clubs 220, Museums 222 and Other 224. Alternatively, the customer may directly enter a specific merchant name or enter his present location in the address bar 226 (if not already determined by GPS software or otherwise within the PCD) and then launching 228 the application.

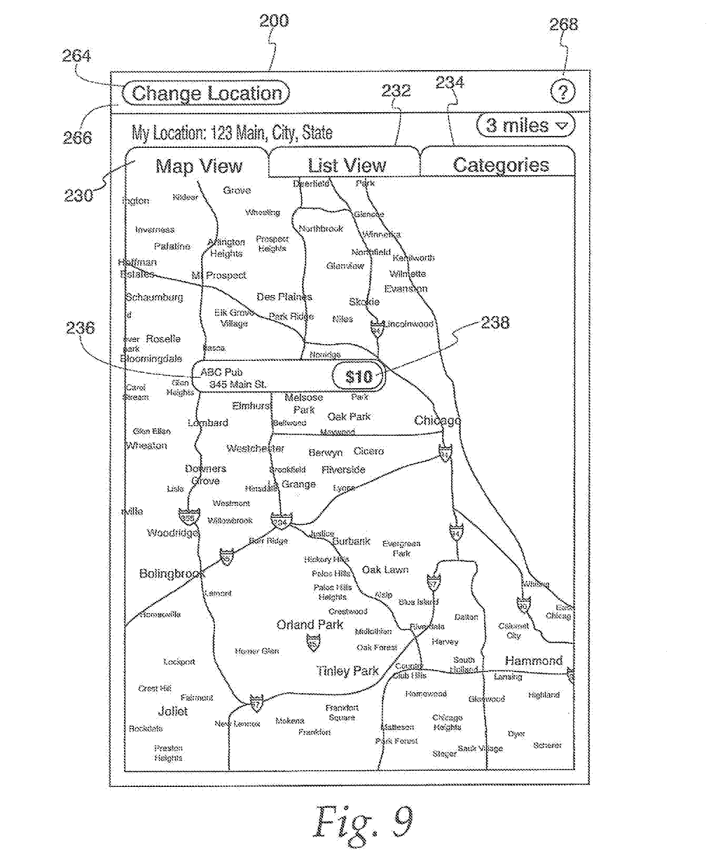

In any event, once activated, the PCD 200 can display available merchants in any number of ways. For example, FIGS. 9-11 illustrate a map display 230, a listing display 232 and a category display 234, respectively. The customer merely activates a display by choosing its tab. If the customer desires to view merchants with a map overlay, as illustrated by FIG. 9, then the merchants will be identified 236 together with their current Pass price 238.

If the customer desires to view merchant's choices by a listing, as illustrated by FIG. 10, then the merchants will be listed according to a default filter (e.g. alphabetically, etc.). Any number of filters may be utilized to organize the listing. For example, by price 240, popularity 242 or proximity 244. In any event, participating merchants information 244a-d together with current Pass price 246a-d will be listed. Additionally, non-participating merchants may also be listed 248a&b.

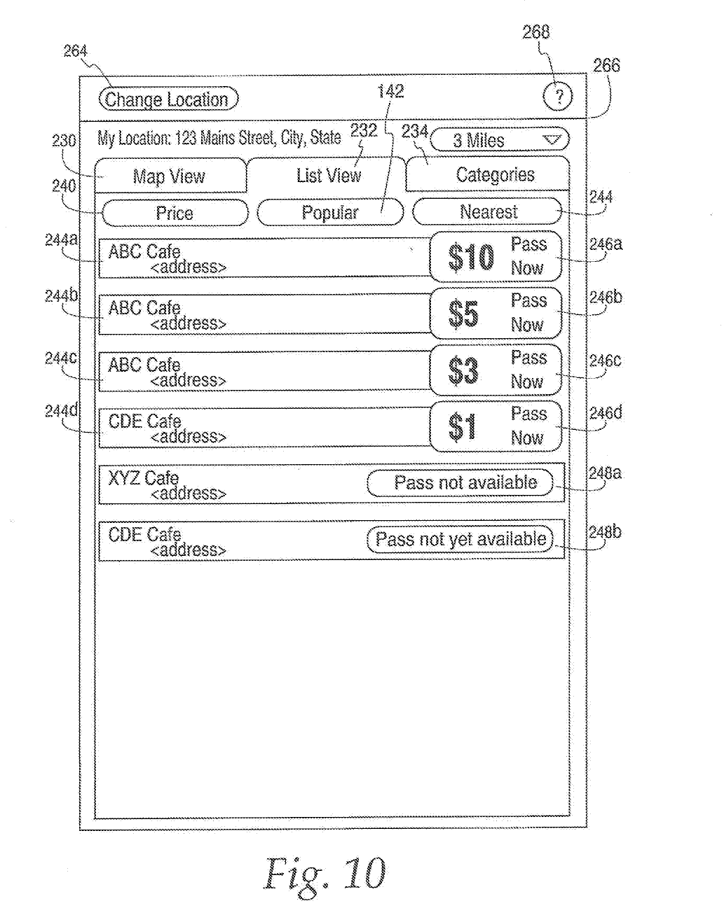

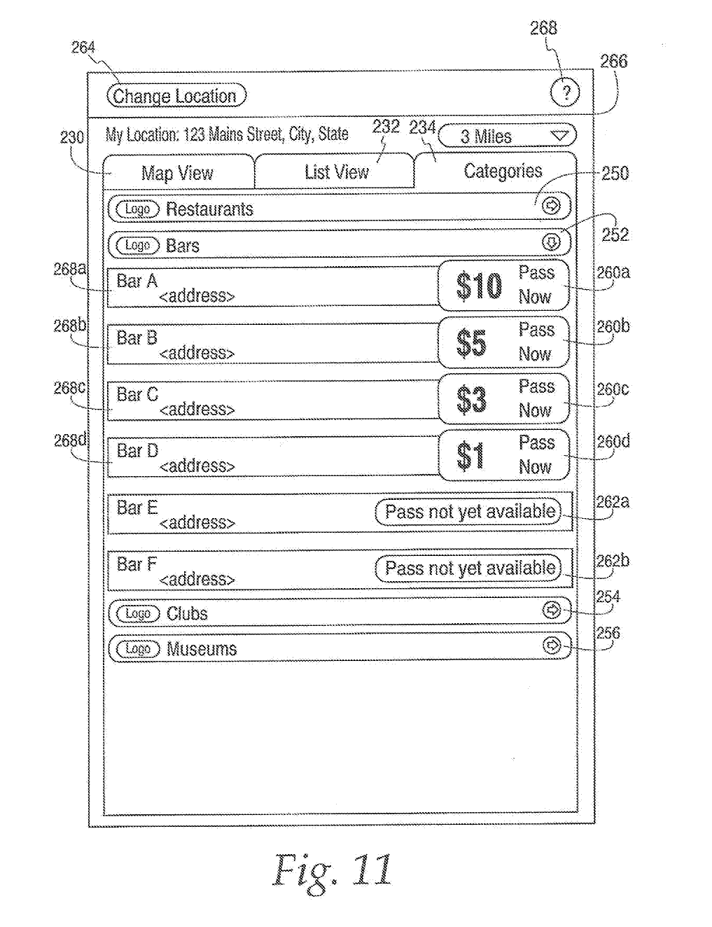

If the customer desires to view merchant choices by their previously created categories, as illustrated by FIG. 11, then the merchants will be listed accordingly. In particular, categories, such as Restaurants, Bars, Clubs and Museums will appear in their respective activatable windows 250, 252, 254 and 256. The category will then expand to display a list of merchants when chosen. For example, if the Bar window 252 is chosen, then merchant Bars will be listed. This list can include both participating merchants 258a-d and their respective Pass prices 260a-d, as well as non-participating merchants 262a&b.

The customer may also have the option of changing his location, and accordingly the merchant listings, by activating the Change Location window 264 within the top tool bar 266. This is available regardless of the viewing option (FIGS. 9-11). Similarly, the tool bar 266, which may show information about the current location, may further include a Help option 268.

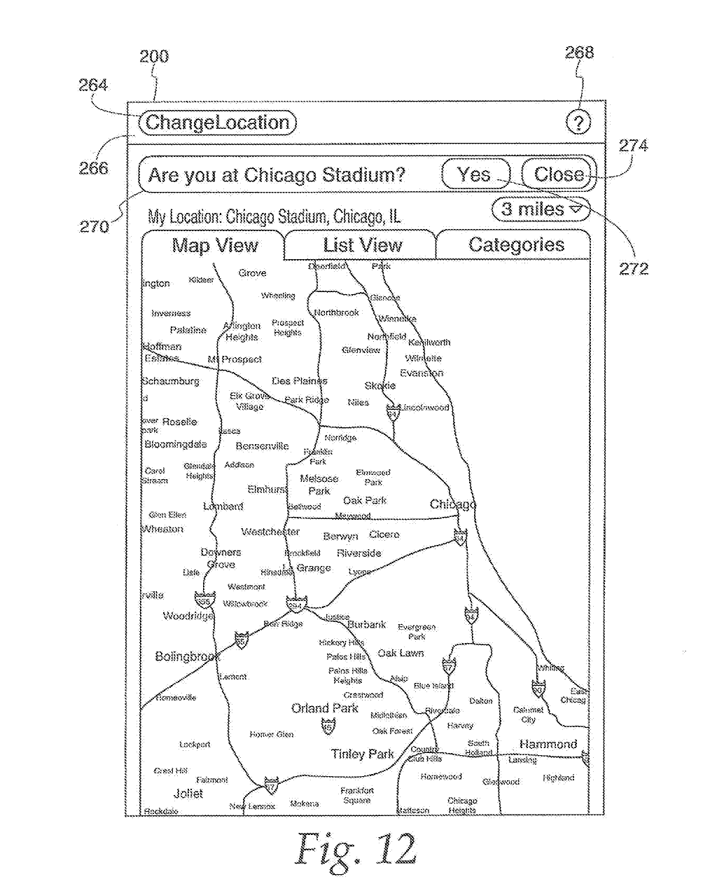

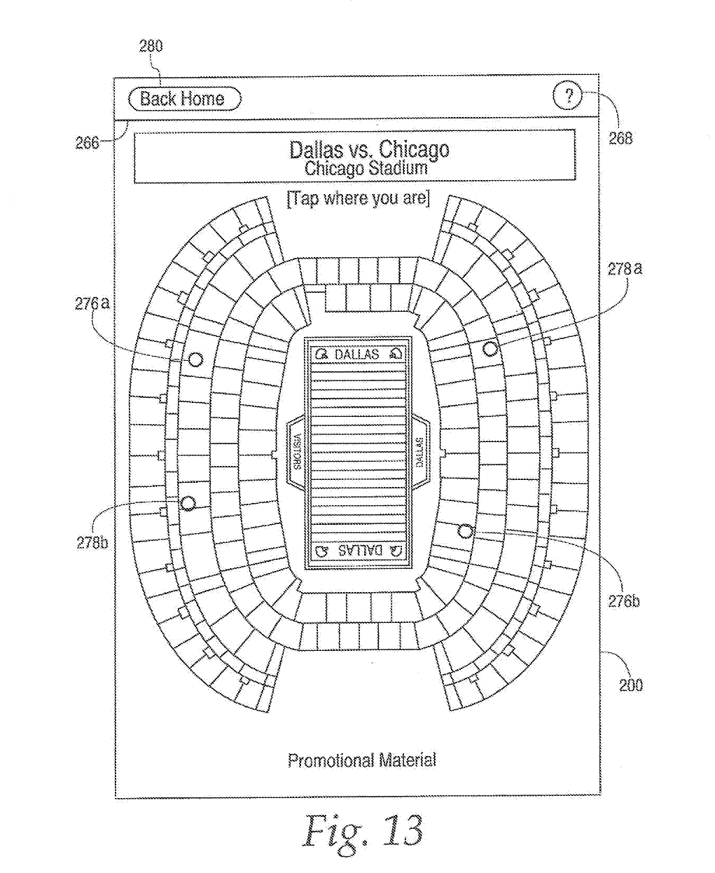

The PCD application may further include a so-called Geo-Feature, which if the user is logged in and the feature is activated, will identify where the PCD (and thus the user) is physically located. Referring to FIG. 12, the Geo-Feature will send a quick message 270 to the smartphone PCD 200. For example, asking “Are you at ______ ?”. User can then choose Yes 272 or No 274. If Yes is chosen, the usual listing displays (e.g. Map View, List View, Categories, etc.) are bypassed and the user is then presented with all available Pass locations within the area. In particular, and turning to FIG. 13, concession Pass locations 276a&b as well as retail Pass locations 278a&b may be presented within a venue (e.g. stadium). The tool bar 266 will provide a choice 280 to exit the Geo-Feature once activated.

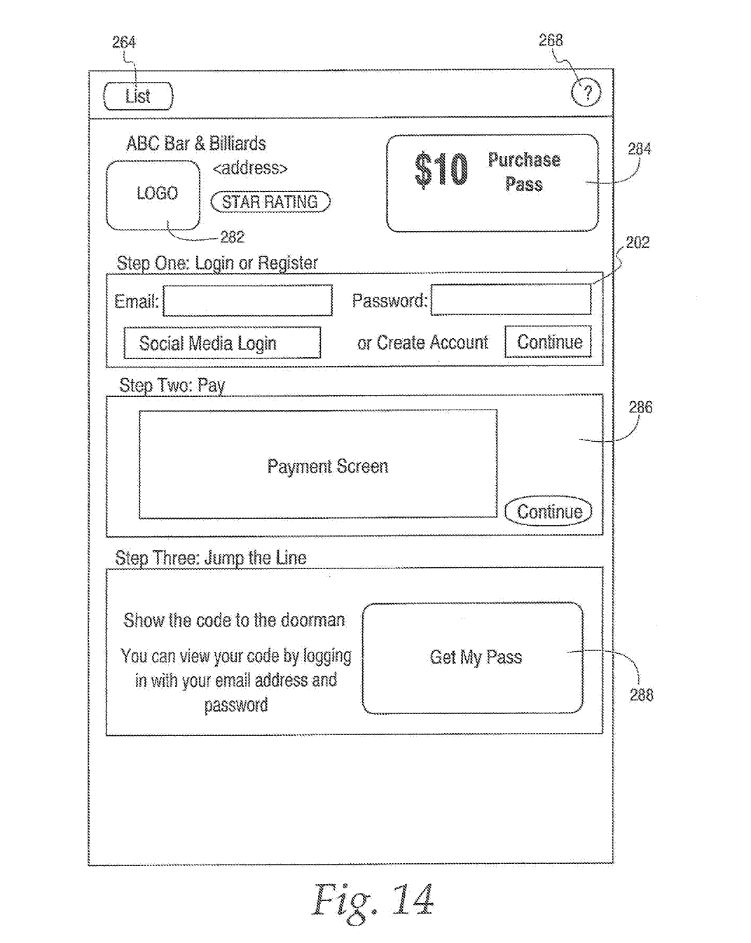

When the customer selects a merchant, as shown in FIG. 14, that merchant's information 282 together with a purchase Pass window 284 is presented. If not currently logged in, or if they need to open an account, the user registers via window 202 as previously discussed. Once logged in the customer decides how may Passes he is purchasing (e.g. if individual Passes are needed, how many people are in his group, etc.). He can then choose how to pay 286 for the Pass, and upon a successful transaction, can obtain the Pass 288. The Pass is then sent to the customer PCD in the form of an alphanumeric code, symbol, Quick Response (“OR”) code, token, coupon, barcode, or any other form of Pass that can be accepted by the merchant.

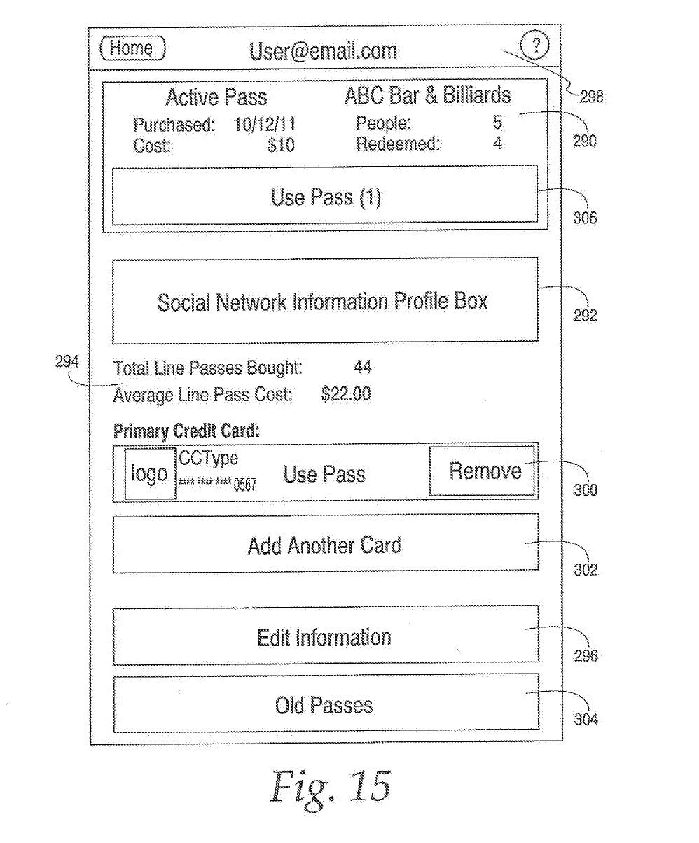

FIG. 15 illustrates some pertinent customer information regarding Passes. In particular, an active Pass window(s) 290 displays Passes available for use. Other information may include a social network information window(s) 292, as well as an accounting 294 of purchased Passes. An Edit Information window 296 will enable the customer to change the accounts 298 pertinent information. Similarly, payment options, including credit cards, may be removed 300 and/or added 302. Furthermore, old Passes 304 may be viewed, but most importantly, active Passes can be used 306.

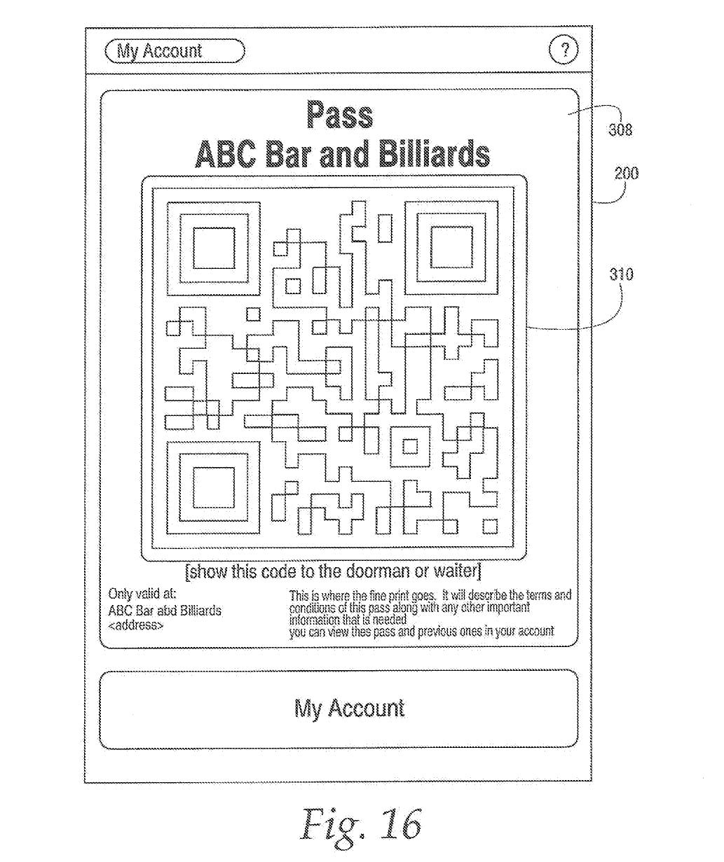

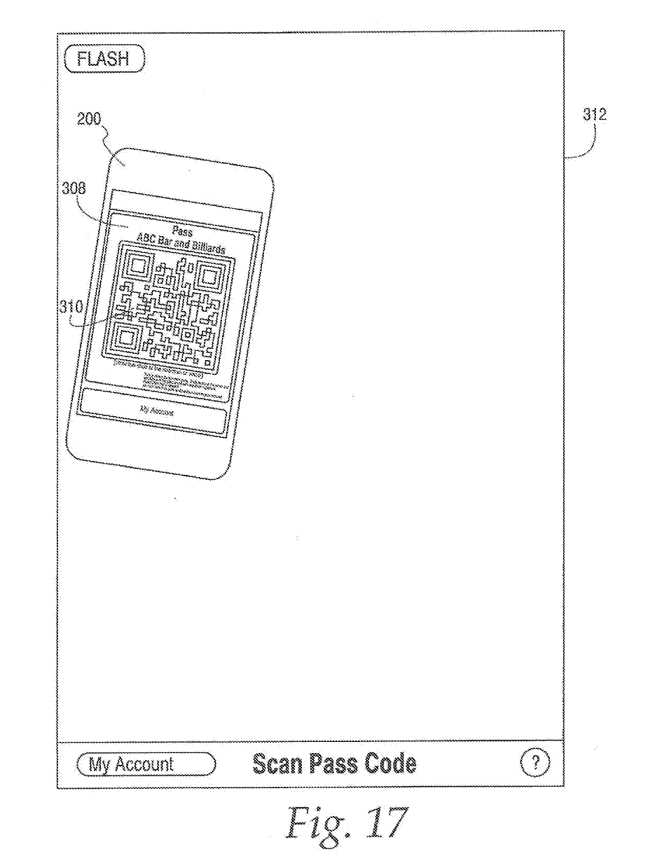

When the customer desires to use the Pass, he activates through Pass window 306 (FIG. 15), and the Pass 308 is displayed on the PCD 200 as a QR code 310, for example, as shown in FIG. 16. The Pass 308 is then shown to the merchant doorman, waiter, etc. and authenticated. Such authentication is preferably in the form of the merchant scanning the customers QR code, see FIG. 17. In particular, the merchant may have a specific scanning device 312 or a PCD similar to the customer PCD 200. In any event, the QR code 310 of the Pass 308 is scanned and authenticated.

The QR code that is downloaded for each customer is full of information used to compile a large demographic database. As members of the service, the data base will be updated to provide additional analytics on member usage patterns that can be later used by merchants for targeting marketing tactics. As an example, if merchants are interested in knowing which customers within a 30 mile radius frequent ABC Steak Houses twice a month, then that information will be available to the merchant. The merchant will then have the ability to send coupons, or discounts to that specific customer and entice them to frequent the merchant location.

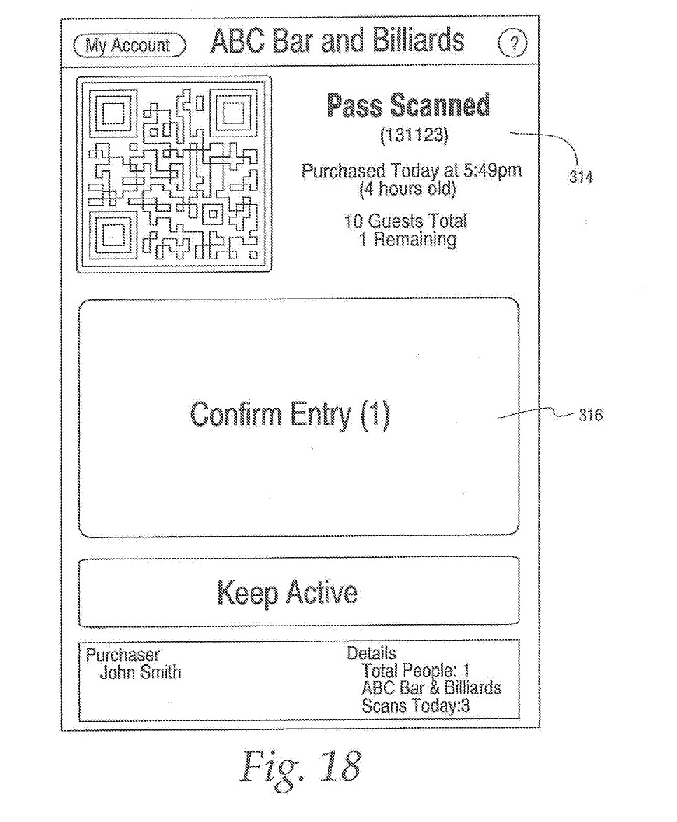

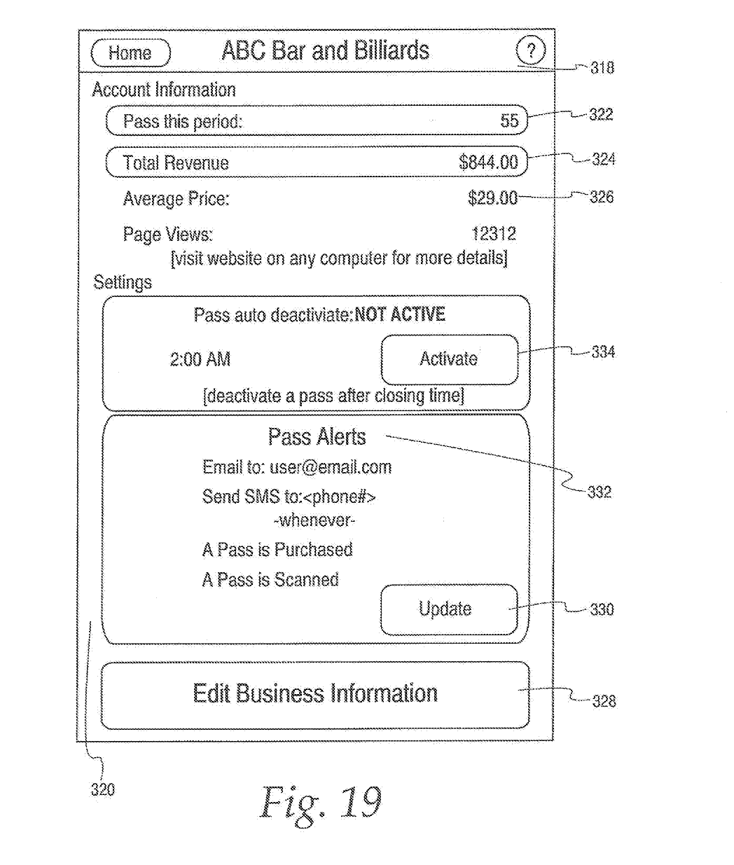

It will be understood that authentication of the Pass need not be via a scanner and may be particular to the merchant. For example, such authentication may be merely visual, direct PCD to PCD wireless communication, wired, or otherwise. Referring back to the preferred scanning and in particular FIG. 18, of the QR code, the merchant, after a successful scan 314, confirms entry 316, and permits the customer to bypass the line. The merchant account 318, see FIG. 19, is immediately updated upon customer entry. A real time report screen 320 can be accessed by the merchant owner/manager regardless of his proximity to his establishment. Such a report may include general account information such as Passes authenticated 322, the total revenue received 324, average price 326, etc. This screen 320 also would allow the owner/manager to Edit his business information 328 as well as update 330 when Pass alerts 332 should be sent and activate 334 other settings.

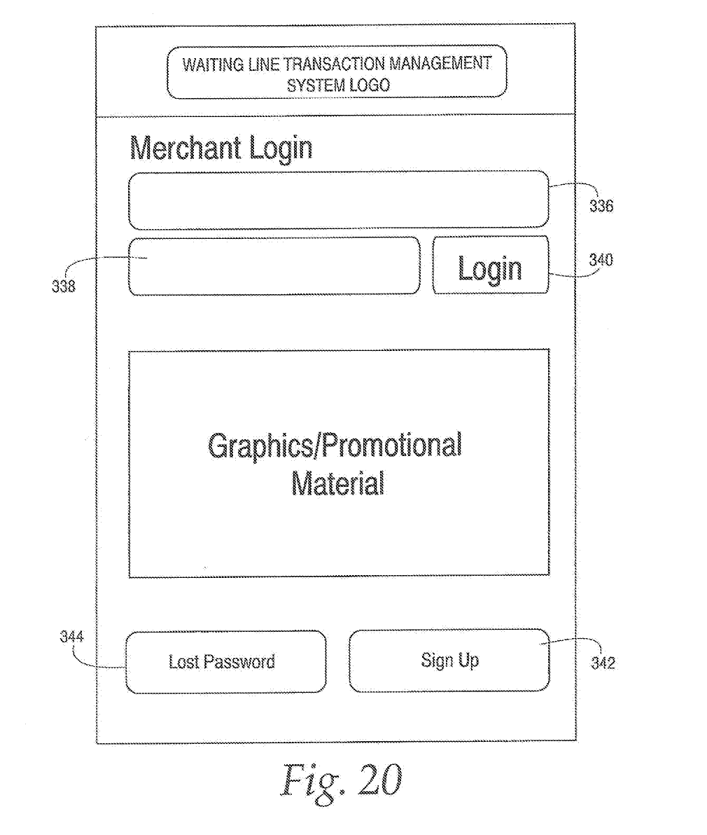

Turning now to the particulars of the merchant ability to utilize the system through their PCD, and first to FIG. 20, the merchant enters his email 336 and password 338 to login 340. Initial Sign-up may be initiated via sign up window 342. If the merchant cannot recall his password, he can have it sent to his email address, phone or otherwise via Lost Password 344.

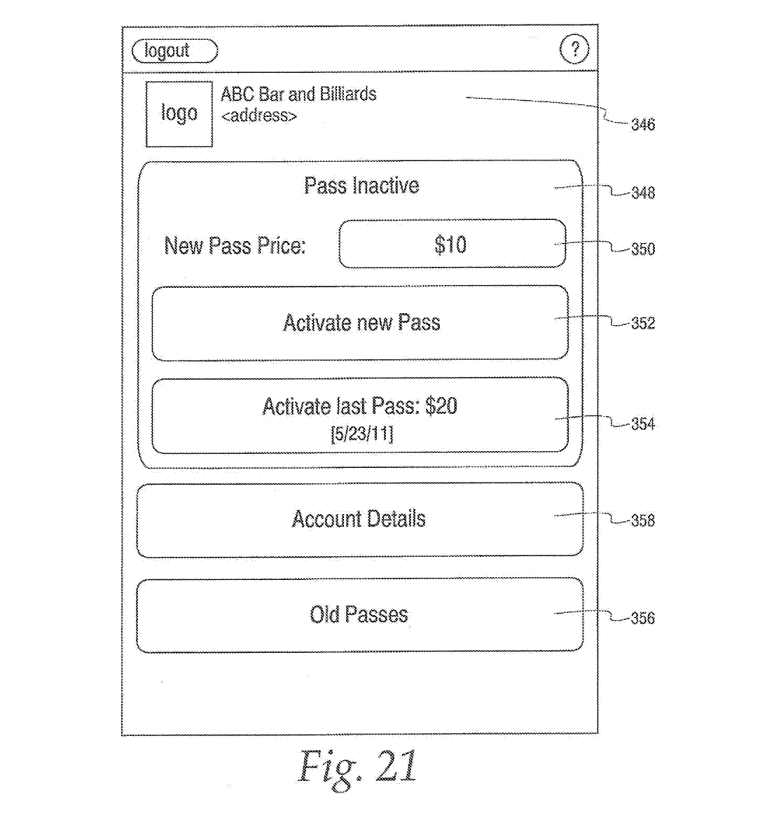

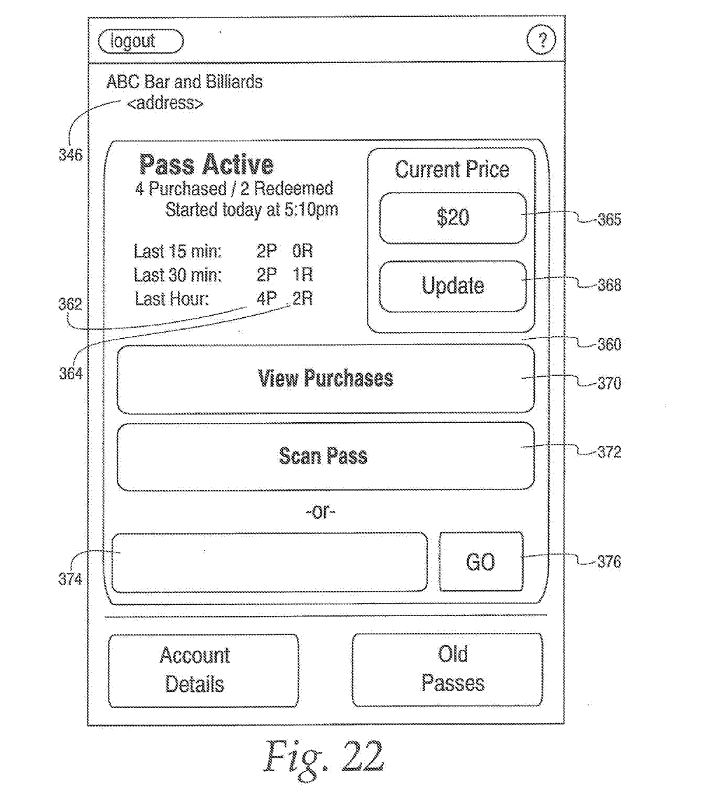

Once logged in, the merchant 346 can either set the ability to sell Passes as inactive (FIG. 21) or as active (FIG. 22). Referring first to FIG. 21, the Pass Inactive window 348 shows the option to set a new Pass price 350 and the options to either activate the new Pass 352 or the last Pass 354. The merchant can also view Old Passes 356 as well as his Account Details 358. Referring now to FIG. 22, the Pass active window 360 shows how many and when Passes have been purchased 362 and redeemed 364, as well as the current price 366 for a Pass and the option of updating 368 the price. The merchant has the ability to instantly change the Pass price point, in order to adjust the length (if any) of the preferred Pass line. With the ability to view how many Passes have been purchased and how many have been redeemed, he can better determine this Pass price point. Over time, merchants can use analytical tools to determine what the optimal Pass price is at various times during the week allowing the merchant to optimize revenue while ensuring the preferred Pass line keeps moving.

The merchant active window 360 further provides the option to view 370 all the purchases. If the merchant PCD is to be used as a Pass authentication device, the merchant can do so by scanning 372 or entering the customer code 374 and authenticating 376. The merchant can further receive Account Details 378 as well as Old Passes 380 from the active screen.

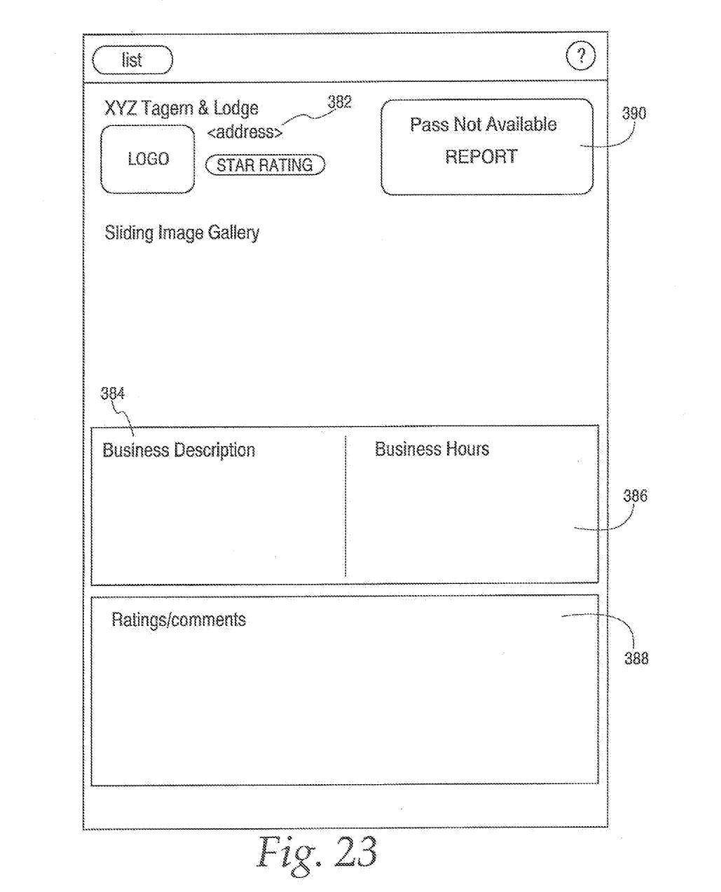

The waiting line transaction management system of the present disclosure includes numerous additional features advantageous to both customer and merchant alike. One such feature is the ability to notify a participating merchant that there is a current line but not an active Pass to purchase, as well as a non-participating merchant. Referring specifically to FIG. 23 as an example, if a customer is scrolling through their choice of local establishments and notices that the XYZ Tavern Lodge is not yet a participating merchant, the customer activates the merchant information page 382. This page may include business description 384, business hours 386, ratings and/or comments 388. Most importantly, the customer can activate the Report window 390. If the merchant is a non-participating merchant, an email will be sent to them informing them that yet another individual is inquiring why they do not honor the Pass system. The email will include a hyperlink to the Pass website, explaining the system for the potential merchant, and in turn, educating the merchant to become a member. If the merchant is already a participating member, they will be alerted that they are currently inactive and a customer desires to purchase a Pass.

The foregoing detailed description has been given for clearness of understanding only and no unnecessary limitations should be understood therefrom. Accordingly, while one or more particular embodiments of the disclosure have been shown and described, it will be apparent to those skilled in the art that changes and modifications may be made therein without departing from the invention if its broader aspects, and, therefore, the aim in the appended claims is to cover all such changes and modifications as fall within the true spirit and scope of the present disclosure.

What is claimed is:

1. A method for skipping a waiting line at a venue, comprising:
registering one or more customer accounts, said customer accounts having a payment preference associated therewith, said customer accounts stored, through a network communication, within a customer database;
registering one or more merchant accounts, said merchant accounts having a fund receiving preference associated therewith, said merchant accounts stored, through a network communication, within a merchant database;
receiving an incoming user communication via a communication network, said incoming user communication containing a unique identifier which is associated with a specific one of said customers in said database;
providing said specific customer with one or more options for identifying a merchant of interest to the customer;
providing said specific customer with information concerning the cost of purchasing a pass to skip a waiting line at the merchant of interest;
receiving a merchant pass selection from said specific customer;
automating payment from said specific customer for said pass selection; and
issuing a pass to said specific customer to skip a waiting line at the merchant wherein said merchant has a validator for authenticating said pass.
